(19) United States
(12) Patent Application Publication
(10) Pub. No.: US 2026/0359042 A1
(43) Pub. Date: Nov. 12, 2026

(54) PROGRAMMING REDUNDANCY MEASUREMENT VIA FUNCTIONALITY CLASSIFICATION

(71) Applicant: International Business Machines Corporation, Armonk, NY (US)

(72) Inventors: Adam Scott Biener, Vestal, NY (US); Laurence Swift, Atlanta, GA (US)

(21) Appl. No.: 19/203,990

(22) Filed: May 9, 2025

(51) Int. Cl. G06F 8/75

(52) U.S. Cl. CPC G06F 8/751

(57) ABSTRACT

Systems or techniques that facilitate programming redundancy measurement via functionality classification are provided. In various embodiments, a system can access two or more codebases. In various aspects, the system can render a visualization illustrating an amount of overlap between the two or more codebases, wherein the visualization is based on a code functionality classification process. In various instances, the system can perform the code functionality classification process by executing a supervised classifier and a large language model on respective files of the two or more codebases.

### BACKGROUND

The subject disclosure relates to codebase maintenance. When given two or more codebases, it can be desired to determine how much programming redundancy there is between such codebases. Existing techniques for facilitating such determination rely on keyword searching. Unfortunately, such existing techniques do a poor job of identifying programming redundancy.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate programming redundancy measurement via functionality classification are described.

According to one or more embodiments, a system is provided. In various aspects, the system can comprise a processor that can execute computer-executable instructions stored in a non-transitory computer-readable memory. In various instances, such execution can cause the processor to facilitate various operations. In various cases, such operations can include accessing two or more codebases. In various aspects, such operations can include rendering a visualization illustrating an amount of overlap between the two or more codebases, wherein the visualization is based on a code functionality classification process. In various instances, such operations can include performing the code functionality classification process by executing a supervised classifier and a large language model on respective files of the two or more codebases.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates programming redundancy measurement via functionality classification in accordance with one or more embodiments described herein.

FIG. 2 illustrates a block diagram of an example, non-limiting system including a code functionality classification process that facilitates programming redundancy measurement via functionality classification in accordance with one or more embodiments described herein.

FIGS. 3-6 illustrate example, non-limiting block diagrams showing how a code functionality classification process can be performed via a supervised classifier and a large language model in accordance with one or more embodiments described herein.

FIG. 7 illustrates a block diagram of an example, non-limiting system including an overlap visualization that facilitates programming redundancy measurement via functionality classification in accordance with one or more embodiments described herein.

FIG. 8 illustrates an example, non-limiting block diagram showing an overlap visualization in accordance with one or more embodiments described herein.

FIG. 9 illustrates an example, non-limiting block diagram showing how various artificial intelligence models can be trained in accordance with one or more embodiments described herein.

FIG. 10 illustrates a flow diagram of an example, non-limiting computer-implemented method that facilitates programming redundancy measurement via functionality classification in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A codebase can be considered as a collection of source code files (e.g., scripts, configuration files, documentation files, dependency files, test files) that collectively define, constitute, or otherwise make up a given software application.

A computing client (e.g., a human, a juridical entity, or a computerized or artificially intelligent agent) might have, maintain, or otherwise use multiple different software applications, and thus multiple different codebases, at any given time. For example, a manufacturing entity might utilize: a first codebase that governs operation of or predictive maintenance for a conveyor machine; a second codebase that governs operation of or predictive maintenance for a 3D printer; a third codebase that governs operation of or predictive maintenance for a computer numerical control (CNC) fabrication machine; a fourth codebase that manages, monitors, or tracks fabrication progress of any given product that is being fabricated by the manufacturing entity; or a fifth codebase that monitors or tracks raw material inventory consumed by the manufacturing entity. As another example, a banking entity might utilize: a first codebase that governs transaction processing for whatever financial accounts are maintained by the banking entity; a second codebase that governs operation of online or mobile banking apps associated with the banking entity; a third codebase that monitors transactions in search of security anomalies; or a fourth codebase that governs compliance report generation for governmental regulators that oversee the banking entity.

When having, maintaining, or using multiple different codebases at once, the computing client can benefit from there being a low or minimized level of programming redundancy among those multiple different codebases. Programming redundancy can involve the same or similar software logic being duplicated (e.g., copied and pasted, or paraphrased) across different codebases. This can be undesirable for various reasons. First, programming redundancy can significantly increase the burden of maintaining or editing those different codebases. Indeed, whenever an edit is to be made to a duplicated piece of software logic, each individual instance of that duplicated piece of software logic must be found, edited, and tested independently, which can be considered as non-trivial or effort-intensive. Second, programming redundancy can significantly increase security vulnerabilities. After all, if a duplicated piece of software logic is determined to be a security weakness, each individual instance of that duplicated piece of software logic must be rectified with a patch; if even a single instance is mistakenly left unpatched, the security threat that is supposed to be addressed by the patch can persist. Third, programming redundancy can lead to inconsistencies or conflicts between codebases. Indeed, separate instances of a duplicated piece of software logic can tend to diverge (e.g., be edited in different ways) as time goes on, thereby potentially yielding different software behavior and thus engendering developer confusion or lack of codebase interoperability. Fourth, programming redundancy can significantly increase technical debt. After all, each instance of a duplicated piece of software logic consumes a respective amount of computer memory or processing power, thereby exacerbating system clutter. Accordingly, it can be desired to reduce programming redundancy among codebases.

When given two or more codebases, reduction of programming redundancy first requires that the amount of programming redundancy among those two or more codebases be measured, quantified, or otherwise identified. Existing techniques facilitate such measurement, quantification, or identification of programming redundancies via keyword searching. For example, when it is desired to determine whether or not a few particular lines of code are redundantly duplicated across the two or more code bases, a document parser can search through the two or more codebases so as to locate each instance or copy of those few particular lines of code. As another example, the document parser can compare any two codebases to each other in word-by-word or string-by-string fashion, thereby locating lines of code or partial lines of code that those two codebases have in common.

Unfortunately, as the inventors of various embodiments described herein recognized, such existing techniques are syntax-dependent. In other words, the efficacy of such existing techniques to accurately or reliably identify programming redundancy across two or more codebases is significantly affected by the specific programming languages in which and by the specific programming styles according to which those two or more codebases are written.

For example, suppose that a codebase A contains some code lines B which perform some particular operation (e.g., email address validation), and suppose that a codebase C also contains some code lines D that perform that same particular operation. Because the code lines B and the code lines D perform, achieve, or accomplish the same operation as each other, they can be considered as a form of programming redundancy. However, because the keyword searching of existing techniques only searches for identically-written code, such existing techniques might not be able to locate or determine that the code lines B and the code lines D constitute programming redundancy. For instance, suppose that the codebase A is written in one programming language (e.g., Python) and that the codebase C is instead written in a different programming language (e.g., C++). In such case, the code lines B can be written, formatted, or otherwise expressed using syntax that is not identical to that in which the code lines D are written, formatted, or otherwise expressed, and therefore keyword searching would not determine that the code lines B are duplicative with respect to the code lines D. As another instance, suppose that the codebase A and the codebase C are written in the same programming language as each other. Even in such case, the code lines B might be written according to some programming style (e.g., using particular variable names, using particular amounts of white space or indentations, using particularly inserted or particularly worded comments, using while-loops instead of for-loops), whereas the code lines D might be written according to some different programming style (e.g., using different variable names, using different amounts of white space or indentations, using differently inserted or differently worded comments, using for-loops instead of while-loops). Just as above, this can cause the code lines B to be written, formatted, or otherwise expressed using syntax that is not identical to that in which the code lines D are written, formatted, or otherwise expressed, and therefore keyword searching would not determine that the code lines B are duplicative with respect to the code lines D.

Thus, existing techniques for measuring, quantifying, or otherwise identifying programming redundancy are easily thrown off or distracted by codebase syntax, which can be considered as undesirable or disadvantageous.

Accordingly, systems or techniques that can measure, quantify, or otherwise identify programming redundancy in a more reliable or syntax-agnostic fashion can be desirable.

Various embodiments described herein can address one or more of these technical problems. Various embodiments described herein can include systems, computer-implemented methods, apparatus, or computer program products that can facilitate programming redundancy measurement via functionality classification. In particular, the present inventors realized that programming redundancy between codebases can be more reliably detected by utilizing artificial intelligence classification rather than keyword searching. M ore specifically, various embodiments described herein can leverage artificial intelligence to classify the overall functionalities achieved or performed by respective files that make up codebases, no matter the particular syntaxes in which those codebases are written or formatted. Various embodiments described herein can then extract or classify, also via artificial intelligence, various syntax-independent metadata attributes from those respective files, where the specific attributes extracted or classified can depend upon the functionality classifications of those respective files. Accordingly, various embodiments described herein can measure or quantify an amount of programming redundancy between codebases by determining how many of those extracted or classified metadata attributes are shared or common between the codebases. In this way, programming redundancy can be determined, even between codebases that are written in different programming languages or that are written in the same programming language but according to different programming styles.

Various embodiments described herein can be considered as a computerized tool (e.g., any suitable combination of computer-executable hardware or computer-executable software) that can facilitate programming redundancy measurement via functionality classification. In various aspects, such a computerized tool can have an access component, a classification component, or a display component.

In various embodiments, there can be at least two codebases, each defining or constituting a respective software application. In various aspects, each of the at least two codebases can be made up of any suitable number of respective software files, such as programming scripts, programming configuration files, programming documentation files, programming dependency files, or programming test files.

In various instances, it can be desired to determine an amount of programming redundancy between the at least two codebases. In various cases, the computerized tool can facilitate such determination as described herein.

In various embodiments, the access component of the computerized tool can electronically access the at least two codebases. For instance, the access component can receive, retrieve, or otherwise obtain the at least two codebases from any suitable centralized or decentralized data structures (e.g., graph data structures, relational data structures, hybrid data structures). Accordingly, the access component can be considered as a conduit through which other components of the computerized tool can electronically interact with (e.g., read, write, edit, copy, manipulate, execute, activate, deactivate, modify) the at least two codebases.

In various embodiments, the classification component of the computerized tool can perform a code functionality classification process on each software file of the at least two codebases. In various aspects, the code functionality classification process can involve two stages: a first stage performed via a supervised classifier; and a second stage performed via a large language model (LLM).

In various instances, the classification component can electronically store, maintain, control, or otherwise access the supervised classifier. In various aspects, the supervised classifier can exhibit any suitable artificial intelligence internal architecture, such as a deep learning internal architecture. For example, the supervised classifier can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the supervised classifier can include any suitable numbers of neurons in various layers (e.g., different layers can have the same or different numbers of neurons as each other). As yet another example, the supervised classifier can include any suitable activation functions (e.g., softmax, sigmoid, hyperbolic tangent, rectified linear unit) in various neurons (e.g., different neurons can have the same or different activation functions as each other). As still another example, the supervised classifier can include any suitable interneuron connections or interlayer connections (e.g., forward connections, skip connections, recurrent connections). However, this is a mere non-limiting example. In other aspects, the supervised classifier can exhibit any other suitable type of artificial intelligence internal architecture, such as a support vector machine architecture, a naïve Bayes architecture, a logistic regression architecture, or a decision tree or random forest architecture.

Regardless of its specific internal architecture, the supervised classifier can be configured to classify the functionalities of software files. That is, the supervised classifier can be configured to receive as input a software file and to produce as output a classification label that indicates or specifies to which one of two or more defined functionality categories the inputted software file belongs, where each defined functionality category can be considered as a respective functional objective, task, or goal which might be achieved, accomplished, or served via any individual software file.

In various instances, the classification component can electronically store, maintain, control, or otherwise access the LLM. In various aspects, the LLM can exhibit any suitable deep learning internal architecture. For example, the LLM can include any suitable numbers of any suitable types of layers (e.g., input layer, one or more hidden layers, output layer, any of which can be convolutional layers, dense layers, LSTM layers, transformer layers, non-linearity layers, pooling layers, batch normalization layers, or padding layers). As another example, the LLM can include any suitable numbers of neurons in various layers (e.g., different layers can have the same or different numbers of neurons as each other). As yet another example, the LLM can include any suitable activation functions (e.g., softmax, sigmoid, hyperbolic tangent, rectified linear unit) in various neurons (e.g., different neurons can have the same or different activation functions as each other). As still another example, the LLM can include any suitable interneuron connections or interlayer connections (e.g., forward connections, skip connections, recurrent connections).

Regardless of its specific internal architecture, the LLM can be configured as a generative text-to-text model. That is, the LLM can be configured to receive as input any suitable textual data (which, in various cases, may or may not be accompanied by any suitable numerical data or any suitable graphical data), and the LLM can be configured to produce as output synthesized textual content (e.g., one or more synthesized sentences or sentence fragments) that is semantically or substantively based on such inputted textual data (and based on accompanying numerical or graphical data, as the case may be).

In order to accomplish this, the LLM can be considered as comprising an encoder portion and a synthesizer portion. In various aspects, the encoder portion can be any suitable upstream layers of the LLM that are configured to receive the inputted textual data (and any accompanying numerical or graphical data) and to produce embeddings based on that inputted textual data. In various instances, the synthesizer portion can be any suitable downstream layers of the LLM that are configured to receive those embeddings and to produce the synthesized textual content based on those embeddings.

In various aspects, an embedding produced by the encoder portion of the LLM in response to a piece of inputted textual, numerical, or graphical data can be considered as any suitable mathematical quantity (e.g., scalar, vector, matrix, tensor, tokenization, or any suitable combination thereof) that numerically represents at least some substantive or semantic aspect of that inputted textual, numerical, or graphical data in a low-dimensional fashion. In other words, the embedding can be smaller in terms of size or dimensionality (e.g., in some cases, one or more orders of magnitude smaller) than such inputted textual, numerical, or graphical data; but despite such smaller size, the embedding can nevertheless be considered as substantively or semantically representing such inputted textual, numerical, or graphical data. In still other words, the embedding can be considered as a latent vector representation of such inputted textual, numerical, or graphical data.

Now, for any given software file from the two or more codebases, the classification component can execute the supervised classifier on the given software file, and such execution can yield a classification label. For example, suppose that the supervised classifier exhibits a deep learning internal architecture. In such case, the classification component can feed the given software file to an input layer of the supervised classifier, the given software file can complete a forward pass through one or more hidden layers of the supervised classifier, and an output layer of the supervised classifier can compute the classification label based on activations produced by the one or more hidden layers. In any case, the classification label can be any suitable electronic data indicating or specifying the functionality, task, or objective that is or would be accomplished or achieved by the given software file. As a non-limiting example, if the given software file is utilized by a banking entity, then the functionality, task, or objective might be banking account generation. As another non-limiting example, if the given software file is utilized by an airline entity, then the functionality, task, or objective might be flight scheduling.

Next, the classification component can identify a textual prompt that corresponds or is otherwise linked to the functionality, task, or objective specified by the classification label. In various aspects, that textual prompt can be unstructured or plain text that asks or commands that one or more defined syntax-independent attributes of the given software file be identified. As some non-limiting examples, such syntax-independent attributes might be input data format, output data format, security protocol, or any other suitable type of file metadata that does not depend upon the programming language in which a file is written (e.g., files written in different programming languages can nevertheless handle the same input data format as each other; files written in different programming languages can nevertheless produce the same output data format as each other; files written in different programming languages can nevertheless use the same security protocol as each other). Note that different functionality, task, or objective classes can correspond to different textual prompts and thus to different combinations of syntax-independent attributes. After all, any given syntax-independent attribute (e.g., security protocol) might be of interest for some functionality, task, or objective classes (e.g., banking account generation) but not for other functionality, task, or objective classes (e.g., inventory tracking).

In any case, the classification component can identify the one or more syntax-independent attributes of the given software file, by executing the LLM on both the given software file and the textual prompt. More specifically, the classification component can concatenate the given software file and the textual prompt together (as well as any suitable retrieval-augmented-generation (RAG) references which an embedding search might reveal to be relevant to the given software file or to the textual prompt) and can feed such concatenation to the input layer of the LLM. In various aspects, that concatenation can complete a forward pass through the one or more hidden layers of the LLM, and the output layer of the LLM can calculate one or more additional classification labels based on activations provided by the one or more hidden layers of the LLM.

In various cases, the one or more additional classification labels can be synthesized texts that are based on the given software file and that substantively or semantically respond to the textual prompt. In other words, each additional classification label can be unstructured or plain text that describes, names, or specifies a respective syntax-independent attribute of the given software file that was asked for or demanded by the textual prompt. As a non-limiting example, suppose that the textual prompt asks for or demands identification of the input data format and security protocol utilized by the given software file. In such case, the LLM can produce two additional classification labels: one indicating or specifying what type of input data format the given software file uses (e.g., portable document format (PDF)); and another indicating or specifying what type of security protocol the given software file uses (e.g., role-based authentication (RBA)).

Note that execution of the supervised classifier on the given software file can be considered as performance of a first stage of the code functionality classification process on or with respect to the given software file. Likewise, note that execution of the LLM on the given software file can be considered as performance of a second stage of the code functionality classification process on or with respect to the given software file.

In any case, the classification component can perform the code functionality classification process (e.g., both stages thereof) on each individual software file that belongs to any of the two or more codebases. This can ultimately cause each individual software file to be assigned to a respective functionality class and to have at least some of its syntax-independent attributes identified.

In various embodiments, the display component of the computerized tool can electronically render an overlap visualization on any suitable screen, electronic display, or graphical user interface, based on the functionality class assignments and syntax-independent attribute identifications produced by the code functionality classification process. In various aspects, the overlap visualization can be made up of two or more nodes that are connected to each other by one or more invisible edges. In various instances, each node can be a circle of any suitable diameter, and each invisible edge can connect a center of one node to a center of another node.

In some cases, each node can represent a respective one of the two or more codebases, and the length of each invisible edge can be inversely proportional to the total number of syntax-independent attributes that are shared or common between any two respective nodes. Accordingly, the presence, absence, or extent of visual overlap between any two nodes can be considered as indicating how much programming redundancy there is between whatever codebases are represented by those two nodes. As a non-limiting example, suppose that there are no syntax-independent attributes in common between those two nodes. In such situation, the invisible edge between those two nodes can be at a maximum length such that those two nodes have no amount of visual overlap. As another non-limiting example, suppose that a maximum possible number of syntax-independent attributes are in common between those two nodes. In such situation, the invisible edge between those two nodes can be at a minimum length such that those two nodes have a significant amount of visual overlap (e.g., those two nodes might be concentric). As even another non-limiting example, suppose that there are an intermediate or moderate number of syntax-independent attributes in common between those two nodes. In such situation, the invisible edge between those two nodes can be at an intermediate or moderate length such that those two nodes have a noticeable, but not complete, amount of visual overlap. In some aspects, invisible edge length can be computed in weighted fashion. Indeed, some types of syntax-independent attributes that are in common between any two nodes can be deemed more significant than others and thus can be given heavier weights (e.g., having shared security protocols might be weighted more heavily than having shared input data formats).

In other cases, each node can instead represent a respective functionality, task, or objective class, and the length of each invisible edge can be inversely proportional to the total number of syntax-independent attributes that are shared or common between any two respective nodes. Thus, the presence, absence, or extent of visual overlap between any two nodes can be considered as indicating how much programming redundancy there is between whatever software files belong to the functionality, task, or objective classes that are represented by those two nodes.

In any case, the overlap visualization can be considered as conveying in an easily or readily interpretable fashion how much programming redundancy there is between or among the two or more codebases or between or among specific classes of files that make up the two or more codebases. Thus, a software developer or technician can treat the overlap visualization as a roadmap indicating how much effort will need to be directed at which portions of the two or more codebases so as to reduce such programming redundancy.

Various embodiments described herein can be employed to use hardware or software to solve problems that are highly technical in nature (e.g., to facilitate programming redundancy measurement via functionality classification), that are not abstract and that cannot be performed as a set of mental acts by a human. Further, some of the processes performed can be performed by a specialized computer (e.g., supervised classifier, LLM).

For example, such defined tasks can include: accessing, by a device operatively coupled to a processor, two or more codebases; and rendering, by the device, a visualization illustrating an amount of overlap between the two or more codebases, wherein the visualization is based on a code functionality classification process. In various aspects, such defined tasks can include: performing, by the device, the code functionality classification process by executing a supervised classifier and a large language model on respective files of the two or more codebases. In various instances, for a first file of the two or more codebases, the device can execute the supervised classifier on the first file, thereby yielding a first classification label that specifies a functionality accomplished by the first file. In various cases, the device can access a first textual prompt corresponding to the functionality specified in the first classification label, wherein the first textual prompt requests classification of a set of first attributes exhibited by the first file. In various aspects, the device can execute the large language model on a concatenation of the first file and the first textual prompt, thereby yielding a set of second classification labels that specify the set of first attributes for the first file. In various instances, the visualization can be a node-edge graph whose nodes represent the two or more codebases or instead groups of files belonging to respective functionality classes, and the amount of overlap can be indicated by respective edge lengths between the nodes that are computed in weighted fashion based on how many classified attributes are shared between the two or more codebases or between those groups of files.

Such defined acts are inherently computerized. Indeed, artificial neural networks (e.g., LL Ms, supervised classifiers) are inherently computerized constructs comprising specific software-oriented architectures (e.g., input layers, hidden layers, or output layers, any of which can be made up of trainable or non-trainable internal parameters such as convolutional layers or LSTM layers). Artificial neural networks cannot be trained or executed by the human mind, or by humans with mere pen and paper, in any reasonable or practicable way without computers. Furthermore, the very concept of programming redundancy pertains to how much duplicative or unnecessarily replicated code there is between or among computer software files. It would make no sense whatsoever to discuss the measurement, identification, or quantification of programming redundancy without computers.

Moreover, one or more embodiments described herein can integrate the herein-described teachings into a practical application. As mentioned above, existing techniques identify programming redundancy via keyword searching. Unfortunately, as the present inventors realized, such existing techniques do not reliably or confidently detect programming redundancy, since keyword searching only returns syntactically identical matches. Indeed, for any given snippet of code, keyword searching can be used to locate exact copies of that given snippet of code in different codebases or in different files within a single codebase. However, such keyword searching will not locate any inexact versions or paraphrased substitutes of that given snippet of code. Because different codebases are often written in different programming languages or in the same programming language but according to different programming styles, two snippets of code located in two different codebases or in two different files of a single codebase might not be syntactically identical to each other despite performing the same task or objective as each other (e.g., such two snippets of code might use different function names, might use different variable names, might have different amounts of white space, or might use differently structured iteration loops). Thus, existing techniques can be considered as not reliably detecting programming redundancy.

Fortunately, various embodiments described herein can address or otherwise ameliorate this technical problem. In particular, the present inventors realized that artificial intelligence can be leveraged to detect programming redundancy in a syntax-agnostic fashion (e.g., that is, without being distracted or led astray by non-substantive syntax differences among codebases). In particular, for each software file that makes up two or more codebases, various embodiments described herein can involve: leveraging a supervised classifier to determine the overall functionality accomplished or achieved by that software file; and leveraging an LLM to classify functionality-specific but syntax-independent attributes of that software file. Once this dual-stage classification process is completed for each software file of the two or more codebases, the resulting functionality classifications and syntax-independent attribute classifications can be used to generate a visualization that shows how much overlap (e.g., how much programming redundancy) there is between those two or more codebases (e.g., such visualization can depend upon the weighted or unweighted numbers or counts of shared syntax-independent attributes there are between the two or more codebases or between respective functionality classes of files belonging to those two or more codebases). Note that the supervised classifier and the LLM can be considered as creating or generating their respective inferences based on inputted text, no matter the syntax of that inputted text (e.g., can be trained to generate their respective inferences for inputted software files regardless of what specific programming languages or styles those software files are written in). Thus, various embodiments described herein can be considered as being robust against syntax differences, unlike the keyword searching of existing techniques (e.g., various embodiments described herein can locate functionally identical snippets of code across different codebases or files, even if such snippets are not syntactically identical). In other words, various embodiments described herein can detect or measure programming redundancy more reliably or confidently than existing techniques.

For at least these reasons, various embodiments described herein provide concrete and tangible technical improvements or technical effects in the field of programming or codebase management. Therefore, such embodiments certainly constitute useful and practical applications of computers.

It should be appreciated that the figures and the herein disclosure describe non-limiting examples of various embodiments. It should further be appreciated that the figures are not necessarily drawn to scale.

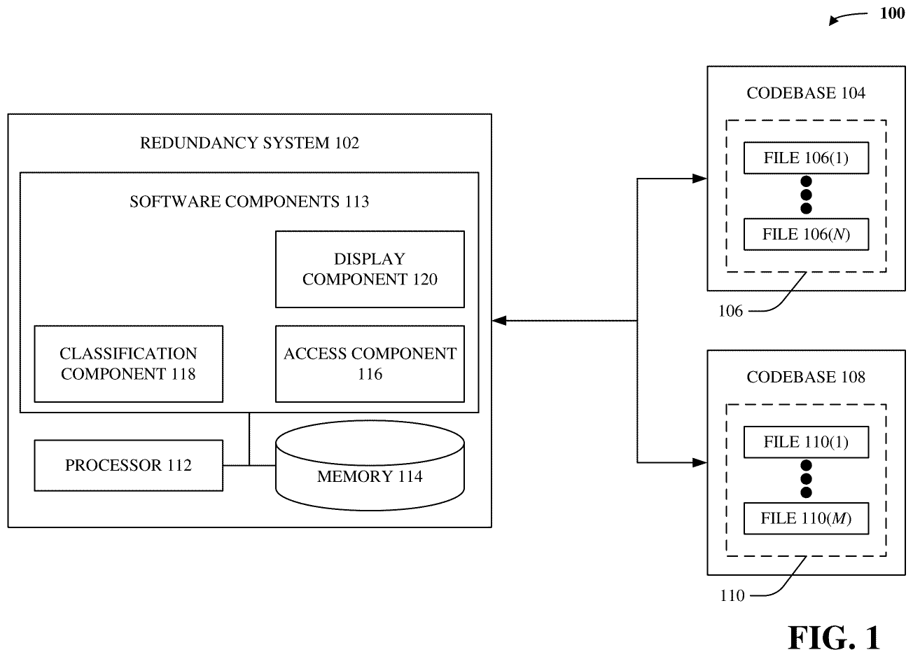

FIG. 1 illustrates a block diagram of an example, non-limiting system 100 that can facilitate programming redundancy measurement via functionality classification in accordance with one or more embodiments described herein. In various cases, a redundancy system 102 can be electronically integrated, via any suitable wired or wireless electronic connections, with a codebase 104 and a codebase 108.

In various embodiments, the codebase 104 can be a source code suite that defines or constitutes any suitable first software application for any suitable computing client. In various aspects, the codebase 104 can include, have, or otherwise be made up of a plurality of files 106. In various instances, the plurality of files 106 can include n files, for any suitable positive integer n>1: a file 106(1) to a file 106(n). In various cases, each of the plurality of files 106 can be any suitable type of textual document whose text is programming code that defines some respective portion of the first software application. As a non-limiting example, any of the plurality of files 106 can be a programming script whose execution can cause or facilitate running of any portion of the first software application. As another non-limiting example, any of the plurality of files 106 can be a programming configuration file that stores selectively configurable or controllable settings or parameters of the first software application. As yet another non-limiting example, any of the plurality of files 106 can be a programming documentation file that can explain in natural language how a respective portion of the first software application is supposed, designed, or intended to work or to be maintained. As even another non-limiting example, any of the plurality of files 106 can be a programming dependency file that lists or specifies any external libraries, packages, or modules that are invoked by a respective portion of the first software application. As still another non-limiting example, any of the plurality of files 106 can be a programming test file whose execution can troubleshoot, validate, or otherwise test a respective portion of the first software application.

Likewise, the codebase 108 can be a source code suite that defines or constitutes any suitable second software application for any suitable computing client. In various aspects, the codebase 108 can include, have, or otherwise be made up of a plurality of files 110. In various instances, the plurality of files 110 can include m files, for any suitable positive integer m>1: a file 110(1) to a file 110(m). In various cases, each of the plurality of files 110 can be any suitable type of textual document whose text is programming code that defines some respective portion of the second software application. As some non-limiting examples, any of the plurality of files 110 can be any suitable programming script, programming configuration file, programming documentation file, programming dependency file, or programming test file of the second software application.

In any case, it can be desired to measure, quantify, determine, or otherwise convey an amount of programming redundancy between the codebase 104 and the codebase 108. In various instances, the redundancy system 102 can accomplish this as described herein.

Although the herein disclosure mainly describes how the redundancy system 102 can measure programming redundancy between the codebase 104 and the codebase 108, this is a mere non-limiting example for ease of explanation and illustration. It should be understood or otherwise appreciated that the redundancy system 102 can be implemented to measure programming redundancy between any suitable number of codebases (e.g., between two or more codebases) or even between the individual files of a single codebase.

In various embodiments, the redundancy system 102 can include a processor 112 (e.g., computer processing unit, microprocessor) and a non-transitory computer-readable memory 114 that is operably connected or coupled to the processor 112. The memory 114 can store computer-executable instructions which, upon execution by the processor 112, can cause the processor 112 or other components of the redundancy system 102 (e.g., access component 116, classification component 118, display component 120) to perform one or more acts. In various embodiments, the memory 114 can store computer-executable components (e.g., access component 116, classification component 118, display component 120), and the processor 112 can execute the computer-executable components.

In various embodiments, the redundancy system 102 can include an access component 116. In various aspects, the access component 116 can electronically access, in any suitable fashion, the codebase 104 or the codebase 108. That is, the access component 116 can electronically receive, electronically retrieve, electronically obtain, or otherwise electronically establish any suitable type of electronic communication with the codebase 104 or the codebase 108, such that any other component of the redundancy system 102 can electronically read, electronically execute, electronically modify, electronically control, electronically manipulate, or otherwise electronically interact with the codebase 104 or with the codebase 108.

In various embodiments, the redundancy system 102 can include a classification component 118. In various aspects, the classification component 118 can, as described herein, perform a code functionality classification process on each file of the codebase 104 and of the codebase 108. Such code functionality classification process can cause each file of the codebase 104 and of the codebase 108 to be assigned to a respective functionality class and to have respective ones of its metadata attributes be identified.

In various embodiments, the redundancy system 102 can include a display component 120. In various instances, the display component 120 can, as described herein, render on any suitable computer screen a visualization that is based on the code functionality classification process, where such visualization can show an amount of programming redundancy or overlap between the codebase 104 and the codebase 108.

Note that, in various instances, the access component 116, the classification component 118, and the display component 120 can collectively be considered as being one or more software components 113 of the redundancy system 102. In various aspects, it should be appreciated that the one or more software components 113 are described primarily herein as comprising three components (e.g., the access component 116, the classification component 118, and the display component 120) for ease of explanation and illustration. However, the one or more software components 113 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 116, the classification component 118, and the display component 120). In other embodiments, the functionalities described herein of such three components can instead be distributed, separated, split, or fragmented in any suitable fashions, so as to be implemented in or by more than three components (e.g., two or more components can facilitate the functionalities that are performable by the access component 116; two or more components can facilitate the functionalities that are performable by the classification component 118; two or more components can facilitate the functionalities that are performable by the display component 120).

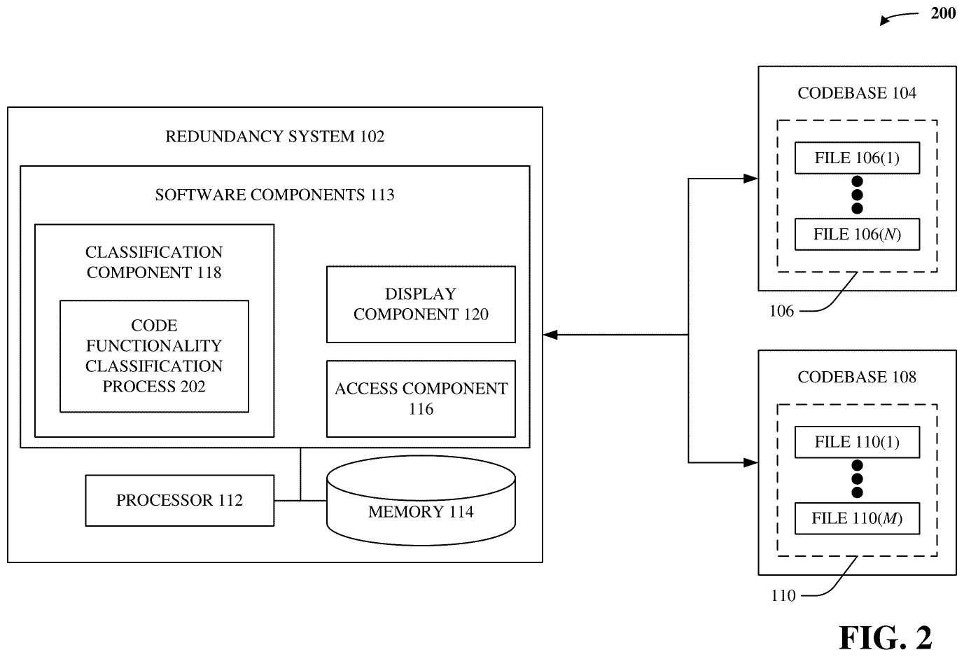

FIG. 2 illustrates a block diagram of an example, non-limiting system 200 including a code functionality classification process that can facilitate programming redundancy measurement via functionality classification in accordance with one or more embodiments described herein. As shown, the system 200 can, in some cases, include the same components as the system 100, and can further include a code functionality classification process 202.

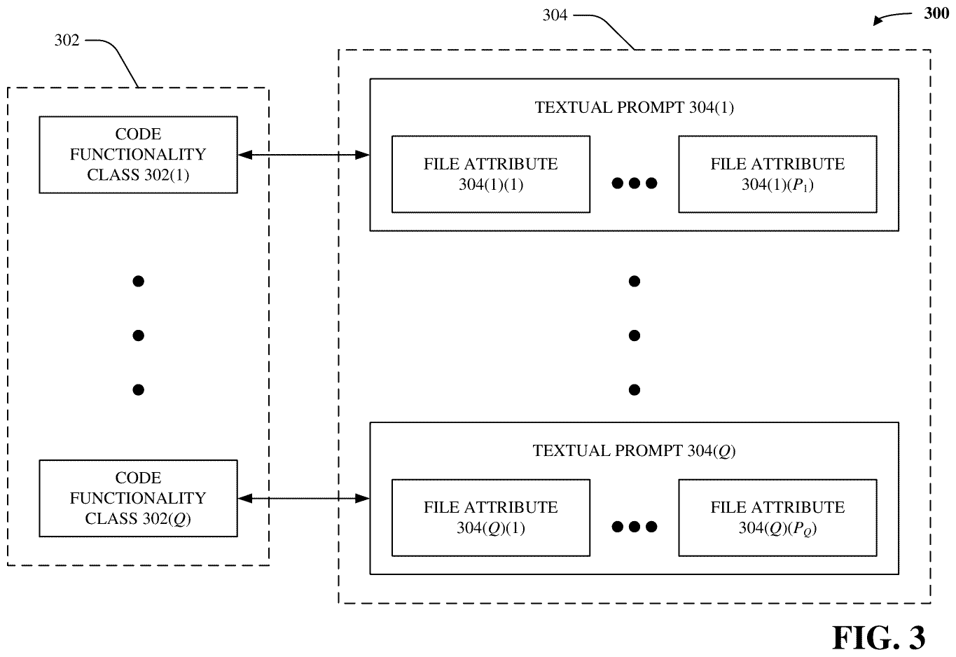

In various embodiments, the classification component 118 can electronically perform the code functionality classification process 202 on each file of the codebase 104 and on each file of the codebase 108. In various aspects, the code functionality classification process can, as its name suggests, involve classifying the functionalities performed, accomplished, or achieved by individual ones of the plurality of files 106 and by individual ones of the plurality of files 110. After classifying such file-wise functionalities, respective metadata attributes of individual ones of the plurality of files 106 and of individual ones of the plurality of files 110 can be classified and compared based on those functionality classifications. In various instances, the numbers of shared or matching metadata attributes can be considered as indicating or conveying how much or how little programming redundancy there is between the codebase 104 and the codebase 108. Accordingly, the code functionality classification process 202 can be considered as a dual-stage procedure, a first stage of which involves classifying functionalities achieved by individual codebase files, and a second stage of which involves classifying metadata attributes of individual codebase files. In various cases, the classification component 118 can perform the first stage of the code functionality classification process 202 by leveraging a supervised classifier and can perform the second stage of the code functionality classification process 202 by leveraging a large language model (LLM). Various non-limiting aspects of the code functionality classification process 202 are described with respect to FIGS. 3-6.

FIGS. 3-6 illustrate example, non-limiting block diagrams 300, 400, 500, and 600 showing how the code functionality classification process 202 can be performed via a supervised classifier and a large language model in accordance with one or more embodiments described herein.

First, consider FIG. 3. In various embodiments, there can be a plurality of code functionality classes 302. In various aspects, the plurality of code functionality classes 302 can include q classes for any suitable positive integer q: a code functionality class 302(1) to a code functionality class 302(q). In various instances, each of the plurality of code functionality classes 302 can be a unique or distinct category of functionality, task, or objective that can possibly be accomplished by a codebase file. In other words, each of the plurality of code functionality classes 302 can represent a principal or primary purpose or responsibility that a codebase file can possibly achieve or serve. As some non-limiting examples, any of the plurality of code functionality classes 302 can be: an account management class, for software files that are responsible for creating, tracking, or terminating customer accounts (e.g., bank accounts, credit card accounts, frequent flier accounts, shopping reward accounts); a marketing class, for software files that are responsible for creating, tracking, or managing advertisement materials (e.g., television commercials, radio advertisements, social media ads); a payment class, for software files that are responsible for tracking or management payments received from customers (e.g., credit card payments, checks, cash, wire transfers, cryptocurrency transfers); an expense class, for software files that are responsible for tracking or managing expenses incurred in the provision of goods or services to customers (e.g., inventory expenses, utility expenses, salaries, wages); a machinery maintenance class, for software files that are responsible for tracking or managing operational status, malfunctions, or wear-and-tear experienced by automated hardware (e.g., CNC machines, 3D printers, conveyors, lathes, furnaces) that helps to provide goods or services to customers; a fleet scheduling class, for software files that are responsible for managing when or where vehicles (e.g., delivery trucks, buses, trains, airplanes, drones, taxis) are dispatched to provide goods or services to customers; or a website class, for software files that are responsible for managing a website with which customers can interact to order or purchase goods or services.

In various aspects, there can be a plurality of textual prompts 304 that respectively correspond (e.g., in one-to-one fashion) to the plurality of code functionality classes 302. Since the plurality of code functionality classes 302 can include q classes, the plurality of textual prompts 304 can thus include q prompts: a textual prompt 304(1) to a textual prompt 304(q). In various cases, each of the plurality of textual prompts 304 can be one or more unstructured or plain text sentences or sentence fragments that request or command identification of various software file attributes which are known or deemed to be of interest for software files that belong to a respective one of the plurality of code functionality classes 302. For instance, the textual prompt 304(1) can correspond to the code functionality class 302(1). Accordingly, the textual prompt 304(1) can be natural language text that asks or demands that a total of p₁ specific file attributes (e.g., a file attribute 304(1)(1) to a file attribute 304(1)(p₁)) be identified for any software file that belongs to the code functionality class 302(1), for any suitable positive integer p₁. As another instance, the textual prompt 304(q) can correspond to the code functionality class 302(q). So, the textual prompt 304(q) can be natural language text that asks or demands that a total of p_{q} specific file attributes (e.g., a file attribute 304(q)(1) to a file attribute 304(q)(p_{q})) be identified for any software file that belongs to the code functionality class 302(1), for any suitable positive integer p_{q}.

In various cases, each file attribute mentioned in any of the plurality of textual prompts 304 can be syntax-independent. In other words, such file attributes can be considered as characteristics that do not vary with programming language (e.g., that span across different programming languages). As some non-limiting examples, any file attribute mentioned by any of the plurality of textual prompts 304 can be: format of data which a software file receives as input (e.g., binary format, JavaScript Object Notation (J SON) format, Extensible Markup Language (XML) format, Hypertext Markup Language (HTML) format, Portable Document Format (PDF) format, Comma Separated Values (CSV) format, PowerPoint Presentation (PPT) format); structure of a database from which a software file reads or extracts input data (e.g., Structured Query Language (SQL) database, Not Only SQL (NoSQL) database, hierarchical database, graph database); format of data which a software file produces as output (e.g., binary format, JSON format, XML format, HTML format, PDF format, CSV format, PPT format); structure of a database to which a software file writes or stores output data (e.g., SQL database, NoSQL database, hierarchical database, graph database); data manipulation methods employed by a software file to convert input data to output data (e.g., binary-to-text translation or vice versa, text-to-text translation such as JSON-to-XML, formulaic computations such as compound interest calculation or heat transfer calculation, notable function calls such as MapReduce or Rasterize); internal structures which a software file uses to convert input data to output data (e.g., three-dimensional arrays, four-or-more-dimensional tensors, trees, lists, graphs); methods by which a software file logs, records, or otherwise tracks internal errors (e.g., file-based logging, console or command line logging, remote or cloud logging, email logging, in-memory or ephemeral logging); or security protocols implemented by a software file to protect its input data or output data (e.g., Role-Based Authorization (RBA) protocol, encryption for data at rest protocol, encryption for data in motion protocol).

Note that different ones of the plurality of textual prompts 304 can request or demand identification of the same or different file attributes as each other. Indeed, in some cases, certain file attributes might be deemed important to identify for software files belonging to some particular code functionality classes, and thus identification of those certain file attributes can be requested or demanded by whatever textual prompts correspond to those particular code functionality classes. On the other hand, those certain file attributes might be deemed unimportant to identify for software files belonging to other code functionality classes, and thus identification of those certain file attributes can be not requested or not demanded by whatever textual prompts correspond to those other code functionality classes.

Note that, in various aspects, each of the plurality of textual prompts 304 can request or demand identification not just of a respective set of metadata attributes, but also identification of the specific lines of code in any given software file that answer that respective set of metadata attributes. As a non-limiting example, the textual prompt 304(1) can request or demand not just identification of the file attribute 304(1)(1), but it can also request or demand identification of the specific lines of code within any given software file that identify, show, prove, or otherwise exhibit the identity of the file attribute 304(1)(1) of that given software file. For instance, if the file attribute 304(1)(1) is data manipulation methods, then the textual prompt 304(1) can request or demand not just identification of the specific data manipulation methods used by a given software file, but it can also request or demand identification of the particular lines of code in that given software file that define, implement, or otherwise constitute those data manipulation methods. In other words, the textual prompt 304(1) can be considered asking that the specific data manipulation methods employed by the given software file be identified and that those specific data manipulation methods be located or localized within the given software file.

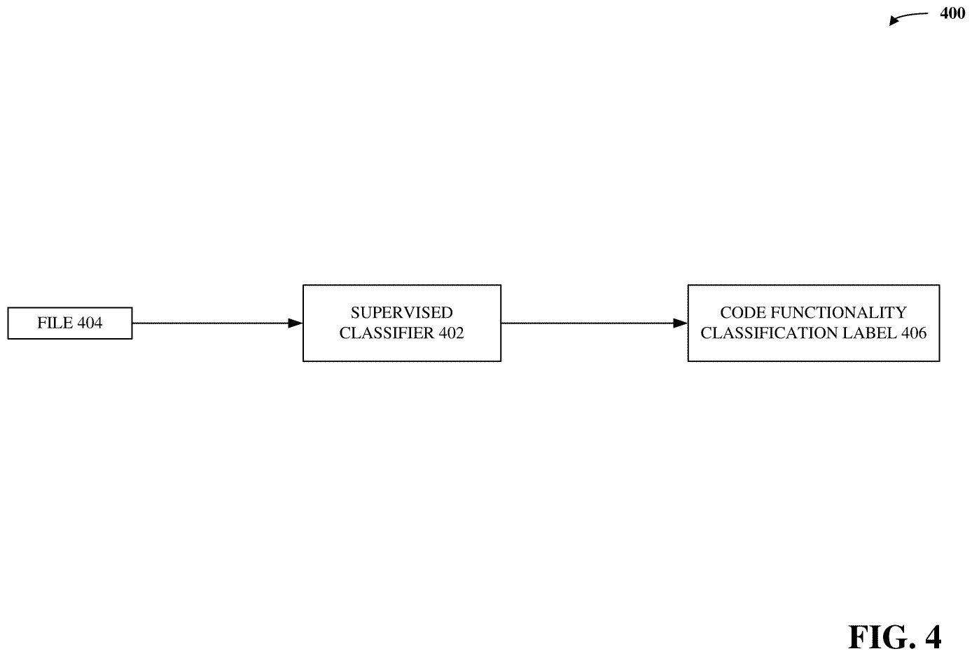

Next, consider FIG. 4. In various embodiments, the classification component 118 can electronically store, electronically maintain, electronically control, or otherwise electronically access a supervised classifier 402. In various aspects, the supervised classifier 402 can exhibit any suitable deep learning internal architecture. Indeed, in various cases, the supervised classifier 402 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

However, these are mere non-limiting examples. In other embodiments, the supervised classifier 402 can exhibit any suitable non-deep-learning internal architecture, such as linear or logistic regression, decision tree or random forest, naïve Bayes, or term-frequency inverse-document-frequency (TF-IDF).

Regardless of the specific internal architecture (e.g., the specific numbers, types, or organizations of layers) that is implemented within the supervised classifier 402, the supervised classifier 402 can be configured to classify the functionalities achieved or accomplished by inputted software files. In various aspects, the classification component 118 can select any one of the plurality of files 106 or any one of the plurality of files 110, and such selected software file can be referred to as a file 404. In various instances, the classification component 118 can electronically execute the supervised classifier 402 on the file 404. In various cases, such execution can yield a code functionality classification label 406. More specifically, the classification component 118 can feed or route the file 404 to the input layer of the supervised classifier 402. In various instances, the file 404 can thus complete a forward pass through the one or more hidden layers of the supervised classifier 402. In various cases, the output layer of the supervised classifier 402 can accordingly compute or calculate the code functionality classification label 406, based on whatever hidden activation maps or hidden feature maps are produced by the one or more hidden layers of the supervised classifier 402 during that forward pass.

In various aspects, the code functionality classification label 406 can be any suitable electronic data exhibiting any suitable format, size, or dimensionality (e.g., can be one or more scalars, one or more vectors, one or more matrices, one or more tensors, one or more character strings, or any suitable combination thereof) that can indicate, convey, or otherwise represent to which one of the plurality of code functionality classes 302 the file 404 belongs. As a non-limiting example, the code functionality classification label 406 can be a q-element vector, where each element of such vector is a real-valued, positive scalar representing a probability that the file 404 belongs to a respective one of the plurality of code functionality classes 302 (e.g., a first element of such q-element vector can represent the likelihood that the file 404 belongs to the code functionality class 302(1); a q-th element of such q-element vector can represent the likelihood that the file 404 belongs to the code functionality class 302(q)). In such situations, the file 404 can be considered as belonging or being assigned to whichever one of the plurality of code functionality classes 302 whose probability is highest in the code functionality classification label 406.

Note that FIG. 4 can be considered as depicting a first stage of the code functionality classification process 202 being applied to the file 404.

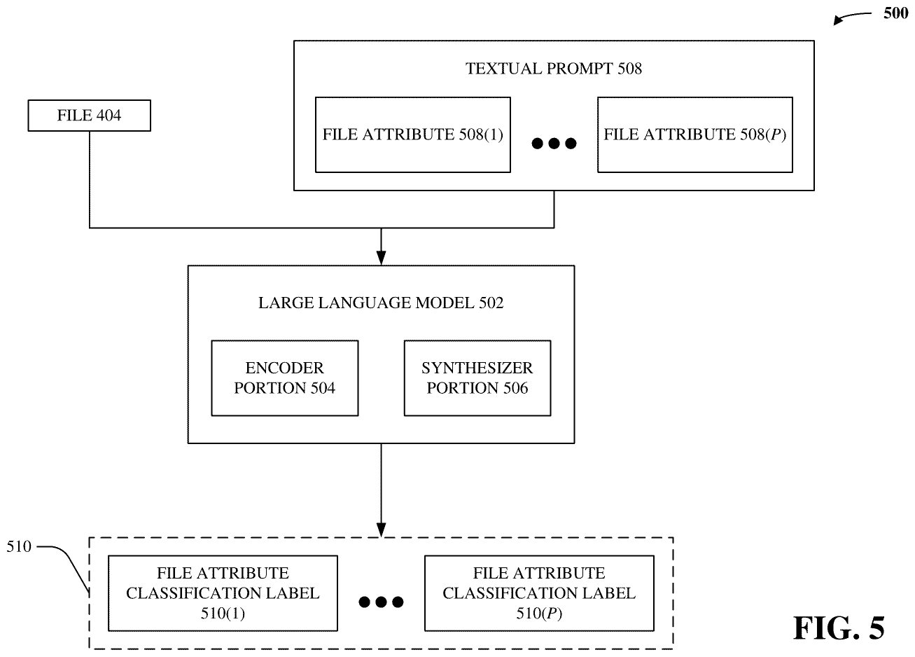

Next, consider FIG. 5. In various embodiments, because the plurality of textual prompts 304 can respectively correspond to the plurality of code functionality classes 302, one of the plurality of textual prompts 304 can correspond to whichever one of the plurality of code functionality classes 302 is indicated by the code functionality classification label 406. For ease of explanation, such textual prompt can be referred to as a textual prompt 508 and can be considered as requesting or demanding identification of a total of p specific file attributes for any suitable positive integer p (e.g., a file attribute 508(1) to a file attribute 508(p)).

In various aspects, the classification component 118 can electronically store, electronically maintain, electronically control, or otherwise electronically access a large language model 502 (hereafter “LLM 502”). In various aspects, the LLM 502 can include or be made up of an encoder portion 504 and a synthesizer portion 506. In various cases, the encoder portion 504 can be considered as being upstream from the synthesizer portion 506. Equivalently, the synthesizer portion 506 can be considered as being downstream of the encoder portion 504.

In various aspects, the encoder portion 504 can exhibit any suitable deep learning internal architecture. Indeed, in various cases, the encoder portion 504 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. As some examples, any of such input layer, one or more hidden layers, or output layer can be convolutional layers, dense layers, batch normalization layers, LSTM layers, or transformer layers. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Likewise, in various instances, the synthesizer portion 506 can exhibit any suitable deep learning internal architecture. Indeed, in various cases, the synthesizer portion 506 can have an input layer, one or more hidden layers, and an output layer. In various instances, any of such layers can be coupled together by any suitable interneuron connections or interlayer connections (e.g., forward connections, skip connections, recurrent connections). Furthermore, in various cases, any of such layers can be any suitable types of neural network layers having any suitable learnable or trainable internal parameters (e.g., any of such input layer, one or more hidden layers, or output layer can be convolutional layers, dense layers, batch normalization layers, LSTM layers, or transformer layers). Further still, in various cases, any of such layers can be any suitable types of neural network layers having any suitable fixed or non-trainable internal parameters (e.g., any of such input layer, one or more hidden layers, or output layer can be non-linearity layers, padding layers, pooling layers, or concatenation layers).

Regardless of the specific internal architecture that is implemented within the encoder portion 504, the encoder portion 504 can be configured to receive textual data (which can be accompanied by any suitable numerical or graphical data) and to produce embeddings based on such inputted textual data. In contrast, regardless of the specific internal architecture that is implemented within the synthesizer portion 506, the synthesizer portion 506 can be configured to receive embeddings produced by the encoder portion 504 and to produce synthesized textual content based on such embeddings. As some non-limiting examples, the LLM 502 can be any of the following: ChatGPT; Gene.AI; Ollama; Bard; or Claude.

In various embodiments, the classification component 118 can electronically execute the LLM 502 on the file 404 and the textual prompt 508. In various cases, such execution can cause the LLM 502 to produce a set of file attribute classification labels 510. More specifically, the classification component 118 can concatenate the file 404 and the textual prompt 508 together. In various instances, the classification component 118 can feed that concatenation to the input layer of the encoder portion 504. In various aspects, that concatenation can complete a forward pass through the one or more hidden layers of the encoder portion 504. In various instances, the output layer of the encoder portion 504 can compute or otherwise calculate one or more embeddings (not shown), based on activation maps or feature maps produced by the one or more hidden layers of the encoder portion 504 during such forward pass. In various cases, those one or more embeddings can be routed to the input layer of the synthesizer portion 506. In various aspects, those one or more embeddings can complete a forward pass through the one or more hidden layers of the synthesizer portion 506, and the output layer of the synthesizer portion 506 can compute or otherwise calculate the set of file attribute classification labels 510 based on activation maps or feature maps provided by the one or more hidden layers of the synthesizer portion 506 during such forward pass.

In various aspects, the set of file attribute classification labels 510 can respectively correspond (e.g., in one-to-one fashion) to the file attributes that are mentioned or recited in the textual prompt 508. Thus, since the textual prompt 508 includes a total of p file attributes, the set of file attribute classification labels 510 can include a total of p labels: a file attribute classification label 510(1) to a file attribute classification label 510(p). In various instances, the set of file attribute classification labels 510 can be one or more unstructured or plain text declarative sentences or sentence fragments that semantically answer the textual prompt 508. In other words, each of the set of file attribute classification labels 510 can be natural language text that identifies (and indicates a location of, as appropriate) a respective one of the p file attributes recited in the textual prompt 508.

As a non-limiting example, the file attribute classification label 510(1) can be synthesized text that indicates the identity of the file attribute 508(1) for the file 404. Suppose that the file attribute 508(1) is output data format. In such case, the file attribute classification label 510(1) can be a declarative sentence or sentence fragment that states or names the particular formats of output data that is or can be produced by the file 404. Moreover, in some cases, the file attribute classification label 510(1) can further state or name the specific lines of code within the file 404 that show or demonstrate usage of those identified output data formats. In other words, the textual prompt 508 can be considered as requesting the specific output data formats of the file 404 to be identified, and the LLM 502 can be considered as evaluating the textual content of the file 404 so as to answer such request.

As another non-limiting example, the file attribute classification label 510(q) can be synthesized text that indicates the identity of the file attribute 508(q) for the file 404. Suppose that the file attribute 508(q) is security protocol. In such case, the file attribute classification label 510(q) can be a declarative sentence or sentence fragment that states or names the particular security protocols that are implemented by the file 404. Moreover, in some cases, the file attribute classification label 510(q) can further state or name the specific lines of code within the file 404 that show or demonstrate usage of those identified security protocols. In other words, the textual prompt 508 can be considered as requesting the specific security protocols used by the file 404 to be identified, and the LLM 502 can be considered as evaluating the textual content of the file 404 so as to answer such request.

Note that FIG. 5 can be considered as depicting a second stage of the code functionality classification process 202 being applied to the file 404.

Although not explicitly shown in FIG. 5, it should be understood or otherwise appreciated that the LLM 502 can be executed on the file 404 and on the textual prompt 508 in RAG fashion. That is, the encoder portion 504 can be used to generate an embedding that represents the file 404 or the textual prompt 508, and the classification component 118 can use that embedding to search through any suitable RAG database for any documentation that might be semantically relevant to the file 404 or to the textual prompt 508. Such documentation can be concatenated with the file 404 and with the textual prompt 508, and the LLM 502 can then be executed on such enlarged concatenation to produce the set of file attribute classification labels 510. Such documentation can thus be considered as rich contextual or supplementary information that can help increase an accuracy or reliability of the set of file attribute classification labels 510.

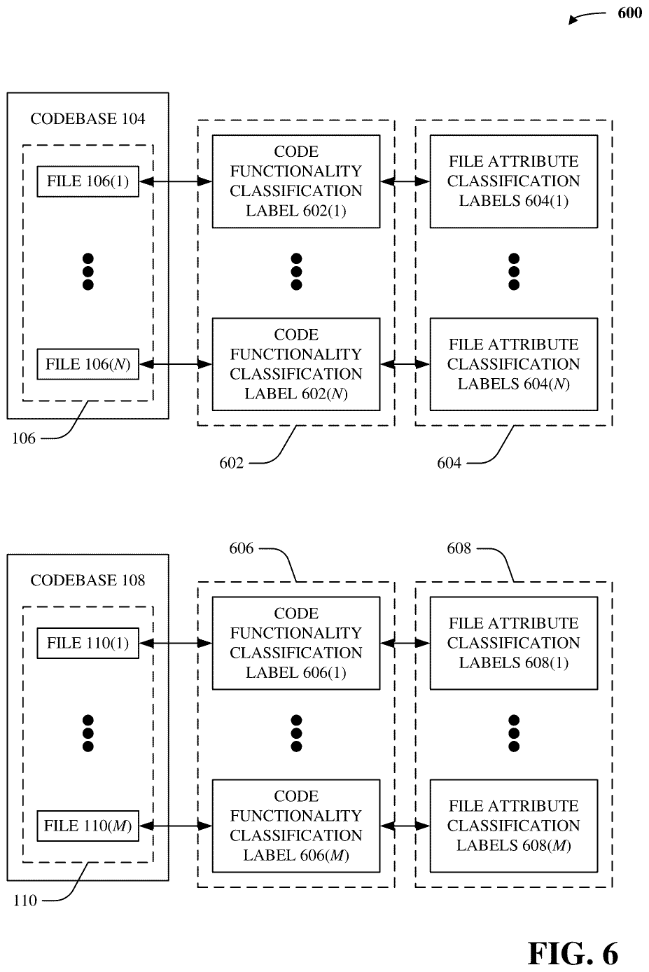

Now, consider FIG. 6. In various embodiments, the classification component 118 can perform both stages of the code functionality classification process 202 on each of the plurality of files 106. Such performance can yield a plurality of code functionality classification labels 602 and a plurality of sets of file attribute classification labels 604. In various aspects, the plurality of code functionality classification labels 602 can respectively correspond to the plurality of files 106. Accordingly, the plurality of code functionality classification labels 602 can include a total of n labels: a code functionality classification label 602(1) to a code functionality classification label 602(n). In various instances, the plurality of sets of file attribute classification labels 604 can also respectively correspond to the plurality of files 106. So, the plurality of sets of file attribute classification labels 604 can include a total of n sets: a set of file attribute classification labels 604(1) to a set of file attribute classification labels 604(n). In various cases, each of the plurality of code functionality classification labels 602 and each of the plurality of sets of file attribute classification labels 604 can be considered as the results of performing the code functionality classification process 202 on a respective one of the plurality of files 106. As a non-limiting example, the code functionality classification label 602(1) can be produced by the supervised classifier 402 in response to execution on the file 106(1), and the set of file attribute classification labels 604(1) can be produced by the LLM 502 in response to execution on the file 106(1) and on whichever one of the plurality of textual prompts 304 corresponds to the code functionality classification label 602(1). As another non-limiting example, the code functionality classification label 602(n) can be produced by the supervised classifier 402 in response to execution on the file 106(n), and the set of file attribute classification labels 604(n) can be produced by the LLM 502 in response to execution on the file 106(n) and on whichever one of the plurality of textual prompts 304 corresponds to the code functionality classification label 602(n).

Likewise, the classification component 118 can perform both stages of the code functionality classification process 202 on each of the plurality of files 110, thereby yielding a plurality of code functionality classification labels 606 and a plurality of sets of file attribute classification labels 608. In various aspects, the plurality of code functionality classification labels 606 can respectively correspond to the plurality of files 110, such that it includes a total of m labels: a code functionality classification label 606(1) to a code functionality classification label 606(m). In various instances, the plurality of sets of file attribute classification labels 604 can also respectively correspond to the plurality of files 110, such that it includes a total of m sets: a set of file attribute classification labels 608(1) to a set of file attribute classification labels 608(m). As above, each of the plurality of code functionality classification labels 606 and each of the plurality of sets of file attribute classification labels 608 can be considered as the results of performing the code functionality classification process 202 on a respective one of the plurality of files 110. As a non-limiting example, the code functionality classification label 606(1) can be produced by the supervised classifier 402 in response to execution on the file 110(1), and the set of file attribute classification labels 608(1) can be produced by the LL M 502 in response to execution on the file 110(1) and on whichever one of the plurality of textual prompts 304 corresponds to the code functionality classification label 606(1). As another non-limiting example, the code functionality classification label 606(m) can be produced by the supervised classifier 402 in response to execution on the file 110(m), and the set of file attribute classification labels 608(m) can be produced by the LLM 502 in response to execution on the file 110(m) and on whichever one of the plurality of textual prompts 304 corresponds to the code functionality classification label 606(m).

In various embodiments, the classification component 118 can electronically quantify an amount of programming redundancy between the codebase 104 and the codebase 108, based on comparing the plurality of sets of file attribute classification labels 604 to the plurality of sets of file attribute classification labels 608. Indeed, in some aspects, that amount of programming redundancy can be based on counting how many file attribute classification labels are shared or in common between the codebase 104 and the codebase 108. More specifically, each file attribute specified by any of the plurality of textual prompts 304 can be considered as a category of potential overlap or potential programming redundancy between the codebase 104 and the codebase 108. By counting how many total instances of sharing or commonality there are between the codebase 104 and the codebase 108 for each of those categories of potential overlap and summing all those counts together in unweighted or weighted fashion, a scalar similarity score can be computed that represents how much overlap or redundancy there is between the codebase 104 and the codebase 108.

As a non-limiting example, suppose that there is only one file attribute of interest: security protocol. Accordingly, the plurality of sets of file attribute classification labels 604 can indicate or name the specific security protocols that are implemented by respective files of the codebase 104. Likewise, the plurality of sets of file attribute classification labels 608 can indicate or name the specific security protocols that are implemented by respective files of the codebase 108. Furthermore, suppose that there are three possible security protocols that can be implemented by any given file: security protocol X, security protocol Y, and security protocol Z.

In various aspects, the classification component 118 can count how many instances of the security protocol X are indicated by the plurality of sets of file attribute classification labels 604, and such count can be denoted as x₁. Likewise, the classification component 118 can count how many instances of the security protocol X are indicated by the plurality of sets of file attribute classification labels 608, and such count can be denoted as x₂. In various instances, min (x₁,x₂) can be considered as being the number of shared or common instances of the security protocol X between the codebase 104 and the codebase 108.

In various cases, the classification component 118 can count how many instances of the security protocol Y are indicated by the plurality of sets of file attribute classification labels 604, and such count can be denoted as y₁. Likewise, the classification component 118 can count how many instances of the security protocol Y are indicated by the plurality of sets of file attribute classification labels 608, and such count can be denoted as y₂. In various aspects, min (y₁,y₂) can be considered as being the number of shared or common instances of the security protocol Y between the codebase 104 and the codebase 108.

In various instances, the classification component 118 can count how many instances of the security protocol Z are indicated by the plurality of sets of file attribute classification labels 604, and such count can be denoted as z₁. Likewise, the classification component 118 can count how many instances of the security protocol Z are indicated by the plurality of sets of file attribute classification labels 608, and such count can be denoted as z₂. In various cases, min(z₁, z₂) can be considered as being the number of shared or common instances of the security protocol Z between the codebase 104 and the codebase 108.

In various aspects, the classification component 118 can compute a similarity score between the codebase 104 and the codebase 108, by aggregating (e.g., adding or averaging) in weighted or unweighted fashion, those numbers of shared or common instances together. For instance, the similarity score can be equal to wₓ min (x₁,x₂)+w_{y} min(y₁,y₂)+w₂ min(z₁, z₂), where wₓ can be any suitable real-valued scalar weight whose magnitude indicates a level of importance of the security protocol X being shared or redundant, where w_{y} can be any suitable real-valued scalar weight whose magnitude indicates a level of importance of the security protocol Y being shared or redundant, and where w_{z} can be any suitable real-valued scalar weight whose magnitude indicates a level of importance of the security protocol Z being shared or redundant. In such case, as the similarity score rises, the amount of programming overlap or redundancy between the codebase 104 and the codebase 108 can be considered as commensurately rising.

This non-limiting example can be extended to any suitable number of file attributes (e.g., to any suitable number of categories of potential overlap). For instance, suppose that, in addition to security protocol, data manipulation method is another file attribute of interest. Accordingly, the plurality of sets of file attribute classification labels 604 can indicate or name the specific data manipulation methods that are implemented by respective files of the codebase 104. Likewise, the plurality of sets of file attribute classification labels 608 can indicate or name the data manipulation methods that are implemented by respective files of the codebase 108. Furthermore, suppose that there are two possible data manipulation methods that can be implemented by any given file: data manipulation method G, and data manipulation method H.

In various aspects, the classification component 118 can count how many instances of the data manipulation method G are indicated by the plurality of sets of file attribute classification labels 604, and such count can be denoted as g₁. Likewise, the classification component 118 can count how many instances of the data manipulation method G are indicated by the plurality of sets of file attribute classification labels 608, and such count can be denoted as g₂. In various instances, min (g₁,g₂) can be considered as being the number of shared or common instances of the data manipulation method G between the codebase 104 and the codebase 108.

In various cases, the classification component 118 can count how many instances of the data manipulation method H are indicated by the plurality of sets of file attribute classification labels 604, and such count can be denoted as h₁. Likewise, the classification component 118 can count how many instances of the data manipulation method H are indicated by the plurality of sets of file attribute classification labels 608, and such count can be denoted as h₂. In various aspects, min (h₁,h₂) can be considered as being the number of shared or common instances of the data manipulation method H between the codebase 104 and the codebase 108.

Now, in such situations, the classification component 118 can compute the similarity score between the codebase 104 and the codebase 108, by aggregating in weighted or unweighted fashion, all of the abovementioned numbers of shared or common instances of security protocol and data manipulation method together. For instance, the similarity score can be equal to wₓ min(x₁,x₂)+w_{y} min(y₁,y₂)+w_{z} min(z₁,z₂)+w_{g} min(g₁,g₂)+wₕ min(h₁,h₂), where w_{g} can be any suitable real-valued scalar weight whose magnitude indicates a level of importance of the data manipulation method G being shared or redundant, and where wₕ can be any suitable real-valued scalar weight whose magnitude indicates a level of importance of the data manipulation method H being shared or redundant. A gain, as the similarity score rises, the amount of programming overlap or redundancy between the codebase 104 and the codebase 108 can be considered as commensurately rising.

It should be appreciated that any suitable types of weights can be implemented or leveraged by the classification component 118 when computing the similarity score between the codebase 104 and the codebase 108. As a non-limiting example, Jaccard Coefficients can be implemented as such weights. In some cases, such weights can vary in attribute-wise fashion (e.g., such that different file attributes can be assigned different weights, as in the examples above). In other cases, such weights can vary in functionality-wise fashion (e.g., such that different code functionality classes can be associated with different weights).

In any case, the classification component 118 can compute a similarity score between the codebase 104 and the codebase 108, by counting and aggregating how many LLM-inferred file attribute classification labels are shared or common between the codebase 104 and the codebase 108.

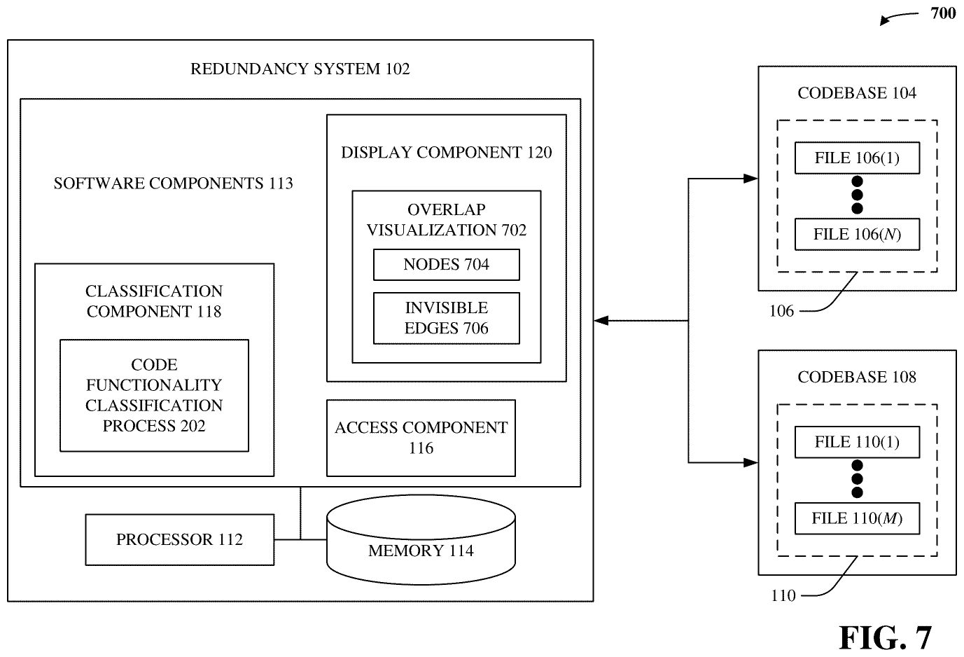

FIG. 7 illustrates a block diagram of an example, non-limiting system 700 including an overlap visualization that can facilitate programming redundancy measurement via functionality classification in accordance with one or more embodiments described herein. In various cases, the system 700 can, as shown, contain the same components as the system 200, and can further include an overlap visualization 702.

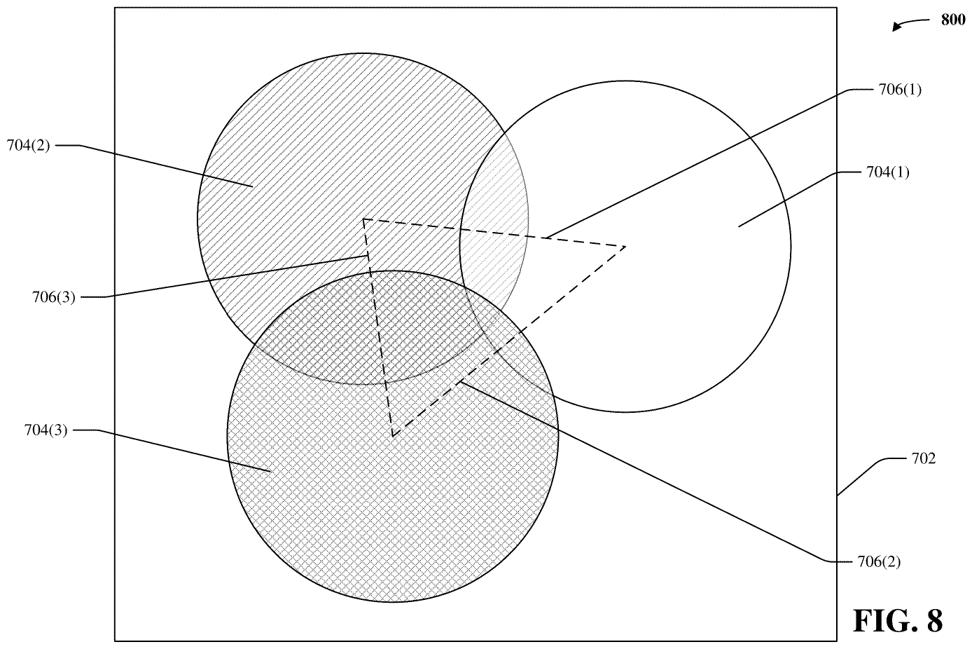

In various embodiments, the display component 120 can electronically render, on any suitable electronic screen or display, the overlap visualization 702. In various aspects, the overlap visualization 702 can be a graphical illustration of the amount of programming redundancy between the codebase 104 and the codebase 108. In various instances, the overlap visualization 702 can be a graph made up of two or more nodes 704 that are coupled together by one or more invisible edges 706. In various cases, one of the two or more nodes 704 can be a circle (or any other shape) that can be considered as representing all software files of the codebase 104 (e.g., that represents the plurality of files 106), and another of the two or more nodes 704 can be a circle (or any other shape) that can be considered as representing all software files of the codebase 108 (e.g., that represents the plurality of files 110). In various aspects, the circles respectively representing the codebase 104 and the codebase 108 can be sized so as to reflect how many files are contained in those codebases (e.g., the codebase with the larger number of files can be represented by a proportionally larger circle). In other aspects, however, the circles respectively representing the codebase 104 and the codebase 108 can be of the same size as each other, regardless of the number of files contained in the codebases. In various instances, the centers of those two circles can be coupled together by one of the one or more invisible edges 706. In various cases, the length of that invisible edge can be inversely proportional to the similarity score which the classification component 118 computes between the codebase 104 and the codebase 108. As a non-limiting example, a minimum possible invisible edge length lₘᵢₙ, a maximum possible invisible edge length lₘₐₓ, a minimum possible similarity score sₘᵢₙ, and a maximum possible similarity score Smax can be defined or otherwise chosen or selected, and the length of the invisible edge that couples the centers of the nodes representing the codebase 104 and the codebase 108 can be equal to

$$1 - ( \frac{s - {s}_{min}}{{s}_{max} - {s}_{min}} ( {l}_{max} - {l}_{min} ) + {l}_{min} ) ,$$

where s represents the similarity score computed between the codebase 104 and the codebase 108. Such formulation causes the length of the invisible edge to shrink as the similarity score increases. This can cause the similarity score, and thus the amount of programming redundancy, between the codebase 104 and the codebase 108 to be quickly visually conveyed by the extent of spatial overlap between the two nodes representing the codebase 104 and the codebase 108. Various non-limiting aspects are described with respect to FIG. 8.

FIG. 8 illustrates an example, non-limiting block diagram 800 showing the overlap visualization 702 in accordance with one or more embodiments described herein.

The codebase 104 can be represented by a node 704(1), the codebase 108 can be represented by a node 704(2), and an invisible edge 706(1) can couple the center of the node 704(1) to the center of the node 704(1). As explained above, a length of the invisible edge 706(1) can decrease as the similarity score between the codebase 104 and the codebase 108 increases. Note, however, that an intersection or amount of Venn-diagram-like spatial overlap that occurs between the node 704(1) and the node 704(2) can grow as the length of the invisible edge 706(1) shrinks. Thus, the spatial size of that intersection of overlap can be considered as conveying how much programming redundancy there is between the codebase 104 and the codebase 108 (e.g., more spatial overlap means more programming redundancy). Accordingly, a technician or software developer who views the overlap visualization 702 can be quickly apprised of how much programming redundancy there is between the codebase 104 and the codebase 108. The technician or software developer can thus be considered as alerted to how much relative effort must be expended to cure, eliminate, or reduce such programming redundancy (e.g., more effort needed as the amount of visual overlap increases).

In some embodiments, intersection or overlap between the node 704(1) and the node 704(2) can be clickable or invokable by the technician or software developer. Clicking or invoking such intersection or visual overlap can reveal the specific locations within the codebase 104 and the codebase 108 that are determined by the classification component 118 to be redundant with each other. After all, each file attribute classification label produced by the LLM 502 can, in various cases, specify the particular lines of code that caused the LLM 502 to identify a respective file attribute, and so clicking or invoking the intersection or visual overlap can yield, recall, or show whatever particular lines of code which the classification component 118 determined were evidence of shared or common file attributes. Such intra-file localization of programming redundancy can be considered as further easing the job of the technician or software developer in reducing or addressing such programming redundancy (e.g., the technician or software developer can be immediately apprised of which specific lines of code in the codebase 104 and the codebase 108 are functionally redundant with each other, even if such specific lines of code are not syntactically identical).

In various embodiments, more than two codebases can be analyzed for programming redundancy as described herein. As a non-limiting example, a node 704(3) can represent a third codebase (not shown). In various aspects, the classification component 118 can perform the code functionality classification process 202 on all of the software files that make up that third codebase. In various instances, the classification component 118 can thus compute a similarity score by aggregating in weighted or unweighted fashion the counts of shared file attributes between the codebase 104 and that third codebase. In various cases, an invisible edge 706(2) can connect the center of the node 704(1) to the center of the node 704(3), and a length of the invisible edge 706(2) can be inversely proportional to the similarity score between the codebase 104 and that third codebase. As can be seen in the non-limiting example of FIG. 8, the amount of visual overlap between the node 704(1) and the node 704(3) is smaller than that between the node 704(1) and the node 704(2). This can be considered as signifying that the codebase 104 has more programming redundancy with the codebase 108 than with that third codebase. Furthermore, an invisible edge 706(3) can connect the center of the node 704(2) to the center of the node 704(3), and a length of the invisible edge 706(3) can be inversely proportional to the similarity score between the codebase 108 and that third codebase. As can be seen in the non-limiting example of FIG. 8, the amount of visual overlap between the node 704(2) and the node 704(3) is larger than that between the node 704(1) and the node 704(2). Thus, the codebase 108 can be considered as having more programming redundancy with the third codebase than with the codebase 104.

In various embodiments, the overlap visualization 702 can be generated even when only a single codebase is being considered. As a non-limiting example, suppose that only the codebase 104 is of interest. In such situation, each of the two or more nodes 704 can represent a respective one of the plurality of code functionality classes 302. For instance, the node 704(1) can represent all software files of the codebase 104 that are classified by the supervised classifier 402 as belonging to an account generation class, the node 704(2) can represent all software files of the codebase 104 that are classified by the supervised classifier 402 as belonging to a website management class, and the node 704(3) can represent all software files of the codebase 104 that are classified by the supervised classifier 402 as belonging to a marketing class. The classification component 118 can compute similarity scores between those respective classes of software files just as described above (e.g., by aggregating counts of file attributes that are shared or common between those respective classes of software files). Accordingly, the lengths of the invisible edges 706(1), 706(2), and 706(3) can respectively be inversely proportional to those similarity scores.

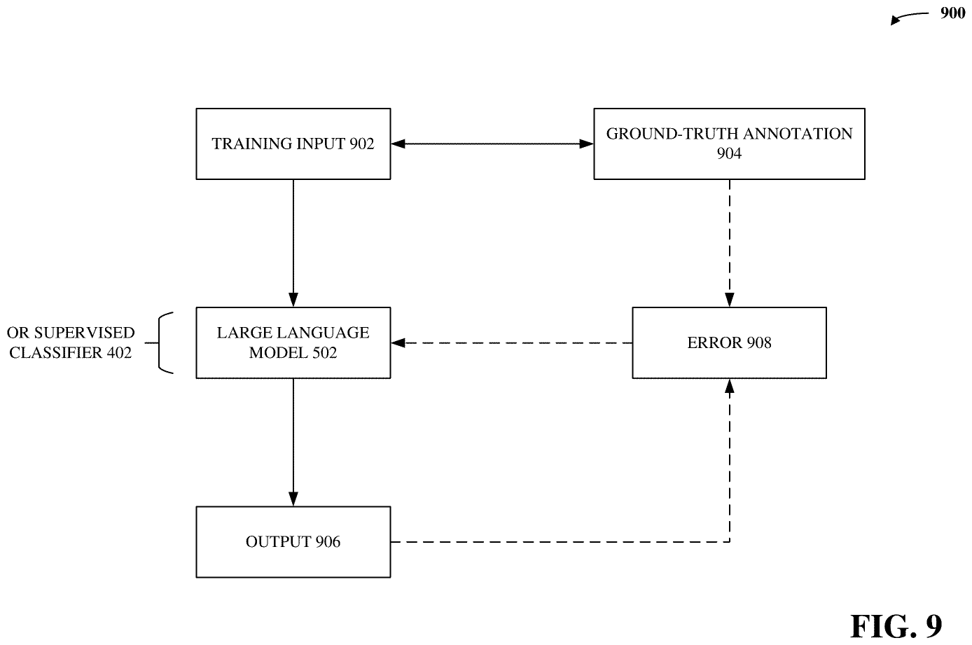

In order for various embodiments described herein to operate reliably, the LLM 502 and the supervised classifier 402 can first undergo training. A non-limiting example of such training is described with respect to FIG. 9.

FIG. 9 illustrates an example, non-limiting block diagram 900 showing how the LLM 502 and the supervised classifier 402 can be trained in accordance with one or more embodiments described herein.

In various aspects, prior to beginning training, the trainable internal parameters (e.g., convolutional kernels, weight matrices, bias values) of the LLM 502 (or of the supervised classifier 402, as appropriate) can be initialized in any suitable fashion (e.g., via random initialization) by the redundancy system 102.

In various embodiments, there can be a training input 902 and a ground-truth annotation 904. When it is desired to train the supervised classifier 402, the training input 902 can be any suitable software file from any suitable codebase, and the ground-truth annotation 904 can be a correct or accurate code functionality classification label that is known or deemed to correspond to the training input 902. When it is instead desired to train the LLM 502, the training input 902 can be any suitable textual, numerical, or graphical data that can be received by the LLM 502 as described herein (e.g., can be a software file concatenated with any suitable textual prompt or with any suitable RAG references), and the ground-truth annotation 904 can be can be whatever correct or accurate synthesized textual content (e.g., correct or accurate file attribute classification labels) that is known or deemed to correspond to the training input 902.

In any case, the redundancy system 102 can cause the LLM 502 (or the supervised classifier 402, as appropriate) to be executed on the training input 902, thereby causing the LLM 502 (or the supervised classifier 402, as appropriate) to produce an output 906. More specifically, in some cases, the training input 902 can be fed or routed to the input layer of the LLM 502 (or of the supervised classifier 402, as appropriate), the training input 902 can complete a forward pass through the one or more hidden layers of the LLM 502 (or of the supervised classifier 402, as appropriate), and the output layer of the LLM 502 (or of the supervised classifier 402, as appropriate) can compute the output 906 based on activation maps or feature maps provided by the one or more hidden layers of the LLM 502 (or of the supervised classifier 402, as appropriate) during such forward pass.

Note that the format, size, or dimensionality of the output 906 can be dictated by the number, arrangement, sizes, or other characteristics of the neurons, convolutional kernels, attention blocks, or other internal parameters of the output layer (or of any other layers) of the LLM 502 (or of the supervised classifier 402, as appropriate). Accordingly, the output 906 can be forced to have any desired format, size, or dimensionality, by adding, removing, or otherwise adjusting characteristics of the output layer (or of any other layers) of the LLM 502 (or of the supervised classifier 402, as appropriate).

In various aspects, if the output 906 is produced by the LLM 502, the output 906 can be considered as the predicted or inferred textual content (e.g., predicted or inferred file attribute classification labels) that the LL M 502 has synthesized based on the training input 902. Instead, if the output 906 is produced by the supervised classifier 402, the output 906 can be considered as the predicted or inferred code functionality classification label that the supervised classifier 402 has produced for the training input 902. In any case, the ground-truth annotation 904 can be considered as whatever correct or accurate result that is known or deemed to correspond to the training input 902. Note that, if the LLM 502 (or the supervised classifier 402, as appropriate) has so far undergone no or little training, then the output 906 can be highly inaccurate. In other words, the output 906 can be very different from the ground-truth annotation 904.

In various aspects, an error 908 (e.g., mean absolute error (MAE), mean squared error (MSE), cross-entropy error) between the output 906 and the ground-truth annotation 904 can be computed by the redundancy system 102. In various instances, the trainable internal parameters of the LLM 502 (or the supervised classifier 402, as appropriate) can be incrementally updated via backpropagation (e.g., stochastic gradient descent) based on the error 908.

In various cases, such execution-and-update procedure can be repeated for any suitable number of input-annotation pairs. This can ultimately cause the trainable internal parameters of the LLM 502 (or of the supervised classifier 402, as appropriate) to become iteratively optimized for accurately performing text synthesis (or for accurately classifying the overall functionality of inputted software files). In various aspects, any suitable training batch sizes, any suitable error/loss functions, or any suitable training termination criteria can be utilized during such training.

Although the herein disclosure mainly describes the LLM 502 and the supervised classifier 402 as being trained in supervised fashion, this is a mere non-limiting example for ease of explanation and illustration. In various embodiments, any other suitable training paradigms can be used to train the LLM 502 or the supervised classifier 402, such as unsupervised training or reinforcement learning, any of which may be federated or unfederated.

Although not explicitly shown in the figures, it should be understood or otherwise appreciated that any suitable cleaning or pre-processing techniques can be applied to any data prior to that data being fed as input to the LLM 502 or to the supervised classifier 402. Non-limiting examples of such cleaning or pre-processing techniques can include converting text to lowercase, removing punctuation, removing stop words, or flattening data into a single text file.

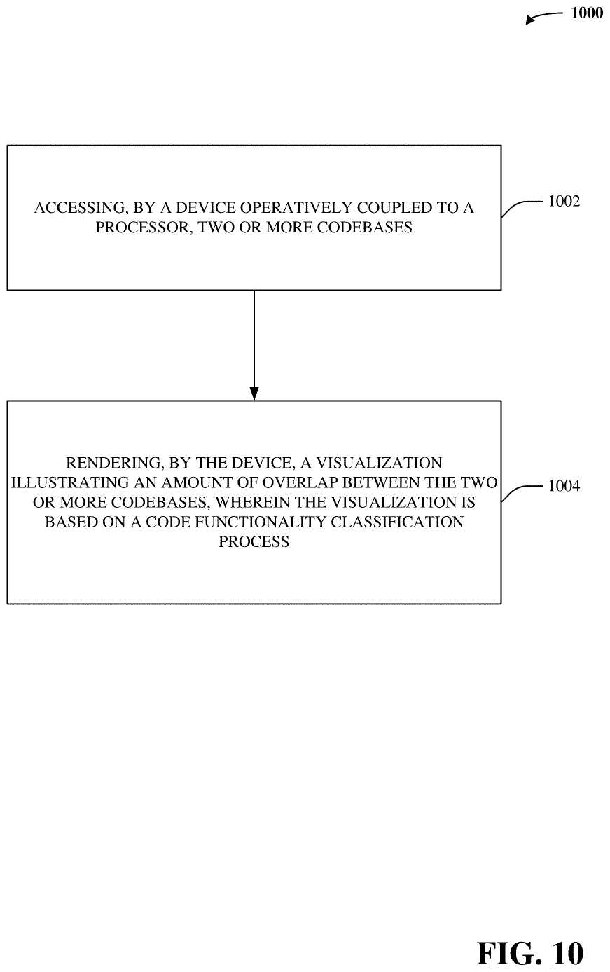

FIG. 10 illustrates a flow diagram of an example, non-limiting computer-implemented method 1000 that can facilitate programming redundancy measurement via functionality classification in accordance with one or more embodiments described herein.

In various embodiments, act 1002 can include accessing, by a device (e.g., via 116) operatively coupled to a processor (e.g., 112), two or more codebases (e.g., 104, 108).

In various aspects, act 1004 can include rendering, by the device (e.g., via 120), a visualization (e.g., 702) illustrating an amount of overlap between the two or more codebases, wherein the visualization is based on a code functionality classification process (e.g., 202).

Although not explicitly shown in FIG. 10, the computer-implemented method 1000 can include performing, by the device (e.g., via 118), the code functionality classification process by executing a supervised classifier (e.g., 402) and a large language model (e.g., 502) on respective files (e.g., 106, 110) of the two or more codebases. In various instances, for a first file (e.g., 404) of the two or more codebases, the device can execute the supervised classifier on the first file, thereby yielding a first classification label (e.g., 406) that specifies a functionality accomplished by the first file. In various cases, the device can access a first textual prompt (e.g., 508) corresponding to the functionality specified in the first classification label, and the first textual prompt can request classification of a set of first attributes (e.g., 508(1) to 508(p)) exhibited by the first file. In various aspects, the device can execute the large language model on a concatenation of the first file and the first textual prompt, thereby yielding a set of second classification labels (e.g., 510) that specify the set of first attributes for the first file.

Although not explicitly shown in FIG. 10, the visualization can be a node-edge graph whose nodes (e.g., 704) represent groups of files having respective functionalities, and wherein the amount of overlap is indicated by respective edge lengths between the nodes that are computed in weighted fashion based on how many classified attributes are shared between those groups of files.

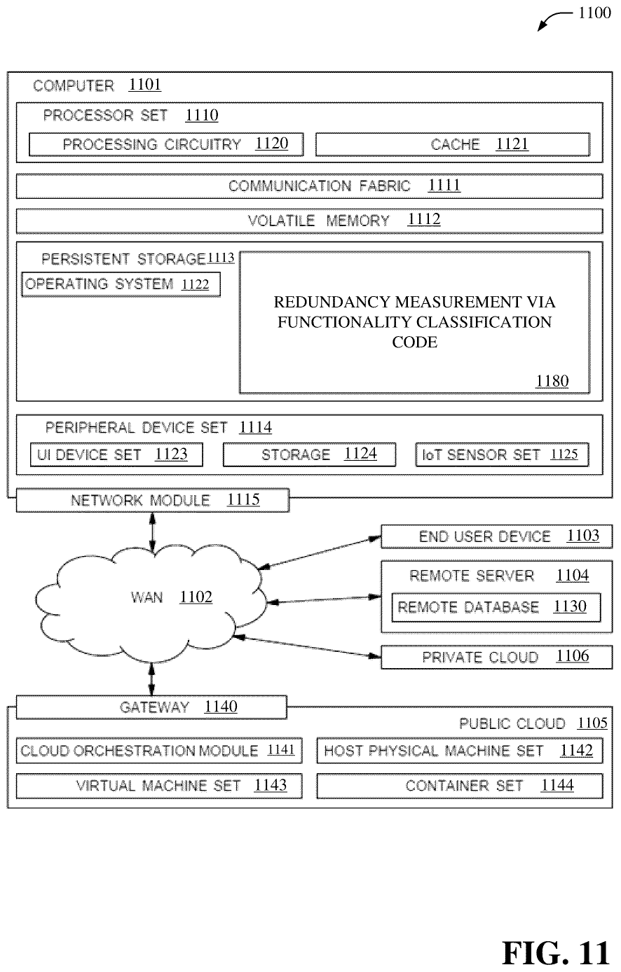

FIG. 11 and the following discussion are intended to provide a brief, general description of a suitable computing environment 1100 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as redundancy measurement via functionality classification code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IOT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing or de-packetizing data for communication network transmission, or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer or desktop computer.

REMOTE SERVER 1104 is any computer system that serves at least some data or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources or other computer capabilities, especially data storage (cloud storage) and computing power, without direct active management by the scale. The direct and active management of the computing resources of public cloud 1105 is performed by the computer hardware or software of cloud orchestration module 1141. The computing resources provided by public cloud 1105 are typically implemented by virtual computing environments that run on various computers making up the computers of host physical machine set 1142, which is the universe of physical computers in or available to public cloud 1105. The virtual computing environments (V CEs) typically take the form of virtual machines from virtual machine set 1143 or containers from container set 1144. It is understood that these V CEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1105 and private cloud 1106 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (A SIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, wherein the computer-executable components comprise:
an access component that accesses two or more codebases; and
a display component that renders a visualization illustrating an amount of overlap between the two or more codebases, wherein the visualization is based on a code functionality classification process.

2. The system of claim 1, wherein the computer-executable components comprise:
a classifier component that performs the code functionality classification process by executing a supervised classifier and a large language model on respective files of the two or more codebases.

3. The system of claim 2, wherein, for a first file of the two or more codebases, the classifier component executes the supervised classifier on the first file, thereby yielding a first classification label that specifies a functionality accomplished by the first file.

4. The system of claim 3, wherein the supervised classifier is an artificial neural network, a naïve Bayes model, a random forest model, or a term-frequency inverse-document-frequency algorithm.

5. The system of claim 3, wherein the classifier component accesses a first textual prompt corresponding to the functionality specified in the first classification label, wherein the first textual prompt requests classification of a set of first attributes exhibited by the first file.

6. The system of claim 5, wherein the set of first attributes includes input data format, output data format, data manipulation method, internal data structure, error logging method, or security protocol of the first file.

7. The system of claim 5, wherein the classifier component executes the large language model on a concatenation of the first file and the first textual prompt, thereby yielding a set of second classification labels that specify the set of first attributes for the first file.

8. The system of claim 7, wherein the large language model is executed in a retrieval-augmented generative fashion.

9. The system of claim 7, wherein the visualization is a node-edge graph whose nodes represent groups of files having respective functionalities, and wherein the amount of overlap is indicated by respective edge lengths between the nodes that are computed in weighted fashion based on how many classified attributes are shared between those groups of files.

10. A computer-implemented method, comprising:
accessing, by a device operatively coupled to a processor, two or more codebases; and
rendering, by the device, a visualization illustrating an amount of overlap between the two or more codebases, wherein the visualization is based on a code functionality classification process.

11. The computer-implemented method of claim 10, further comprising:
performing, by the device, the code functionality classification process by executing a supervised classifier and a large language model on respective files of the two or more codebases.

12. The computer-implemented method of claim 11, wherein, for a first file of the two or more codebases, the device executes the supervised classifier on the first file, thereby yielding a first classification label that specifies a functionality accomplished by the first file.

13. The computer-implemented method of claim 12, wherein the supervised classifier is an artificial neural network, a naïve Bayes model, a random forest model, or a term-frequency inverse-document-frequency algorithm.

14. The computer-implemented method of claim 12, wherein the device accesses a first textual prompt corresponding to the functionality specified in the first classification label, wherein the first textual prompt requests classification of a set of first attributes exhibited by the first file.

15. The computer-implemented method of claim 14, wherein the set of first attributes includes input data format, output data format, data manipulation method, internal data structure, error logging method, or security protocol of the first file.

16. The computer-implemented method of claim 14, wherein the device executes the large language model on a concatenation of the first file and the first textual prompt, thereby yielding a set of second classification labels that specify the set of first attributes for the first file.

17. The computer-implemented method of claim 16, wherein the large language model is executed in a retrieval-augmented generative fashion.

18. The computer-implemented method of claim 16, wherein the visualization is a node-edge graph whose nodes represent groups of files having respective functionalities, and wherein the amount of overlap is indicated by respective edge lengths between the nodes that are computed in weighted fashion based on how many classified attributes are shared between those groups of files.

19. A computer program product for facilitating programming redundancy measurement via functionality classification, the computer program product comprising a non-transitory computer-readable memory having program instructions embodied therewith, the program instructions executable by a processor to cause the processor to:
access two or more codebases; and
render a visualization illustrating an amount of overlap between the two or more codebases, wherein the visualization is based on a code functionality classification process.

20. The computer program product of claim 19, wherein the program instructions are further executable to cause the processor to:
perform the code functionality classification process by executing a supervised classifier and a large language model on respective files of the two or more codebases.
